(19) United States
(12) Patent Application Publication
(10) Pub. No.: US 2025/0367996 A1
(43) Pub. Date: Dec. 4, 2025

(54) LENGTH-ADJUSTABLE SHOCK ABSORBER

(71) Applicant: Yi Fan Chen, Taichung City (TW)

(72) Inventor: Yi Fan Chen, Taichung City (TW)

(21) Appl. No.: 18/732,327

(22) Filed: Jun. 3, 2024

(51) Int. Cl. B60G 15/06

(52) U.S. Cl. CPC B60G 15/06; B60G 2500/30

(57) ABSTRACT

A length-adjustable shock absorber includes a tubular body and an adjusting cylinder. The tubular body has one end formed with threads to form a threaded section. The threaded section is interrupted in an axial direction by at least one recessed groove. The adjusting cylinder is threadedly connected to the threaded section and has at least one through hole. The through hole is rotated along with the adjusting cylinder to face the recessed groove. A locking lever is pivotally connected outside the through hole. The locking lever is pivotable between a locking position and an unlocking position. When the locking lever is pivoted to the locking position, it is engaged in the recessed groove to lock the adjusting cylinder. When the locking lever is pivoted to the unlocking position, it is disengaged from the recessed groove to unlock the adjusting cylinder.

### FIELD OF THE INVENTION

The present invention relates to a shock absorber, and more particularly to a length-adjustable shock absorber.

### BACKGROUND OF THE INVENTION

As a means of transportation, vehicles shuttle across various roads, such as asphalt avenues or muddy paths, the vehicles may bump along the rough roads. Therefore, shock absorbers are installed in vehicles to absorb the vibration caused by bumps during the driving, so as to improve the comfort of drivers and passengers.

However, since there are many vehicle specifications, it is necessary to produce shock absorbers with corresponding lengths according to different vehicle specifications, which leads to an increase in production costs. Therefore, a length-adjustable shock absorber is developed on the market. Taiwan Utility Model Publication No. 392609 discloses an improved vehicle body adjustment structure for vehicular shock absorbers. A shock-absorbing cylinder has a long threaded body extending downwardly. A connecting seat has an internal screw hole corresponding to the threaded body, so that the connecting seat can be threadedly connected to a spindle at a selective height and positioned by a retaining ring.

The height of the screw connection between the connecting seat and the spindle can be adjusted according to different vehicle specifications. However, it is inevitable that dirt, sand and gravel will splash onto the shock absorbers while the vehicle is driving. Because the shock-absorbing cylinder has the threaded body, dirt, sand and gravel accumulate between the threads, which accelerates the rusting of the threads. As a result, it is not easy to loosen the retaining ring to adjust the height of the screw connection, causing inconvenience in use. There is a small gap between the threads. With the vibration of driving, the retaining ring and the spindle may rotate relative to each other, reducing the positioning effect of the retaining ring. This causes the shock absorber to loosen easily and produce a noise.

### SUMMARY OF THE INVENTION

The primary object of the present invention is to provide a length-adjustable shock absorber, comprising a tubular body and an adjusting cylinder. A threaded section of the tubular body is interrupted in an axial direction by at least one recessed groove. The adjusting cylinder has at least one through hole corresponding to the recessed groove. A locking lever is pivotally connected outside the through hole. When the locking lever is pivoted to pass through the through hole and is engaged in the recessed groove, the adjusting cylinder cannot rotate relative to the tubular body, so as to lock the adjusting cylinder. The present invention solves the problem of the noise caused by long-time vibration and relative rotation between the tubular body and the adjusting cylinder. The present invention also avoids the rusting of the threads caused by mud/sand sediment between the threads in the process of driving, which makes it impossible to rotate the adjusting cylinder for adjusting the length.

In order to achieve the foregoing object, the length-adjustable shock absorber provided by the present invention comprises a tubular body and an adjusting cylinder.

The tubular body has one end formed with threads in an axial direction to form a threaded section. The threaded section is interrupted in the axial direction by at least one recessed groove.

The adjusting cylinder is sleeved on the tubular body. The adjusting cylinder is threadedly connected to the tubular body at a selective height for adjusting a length that the tubular body extends out of the adjusting cylinder.

A circumferential side of the adjusting cylinder has at least one through hole. The through hole is rotated along with the adjusting cylinder to face the recessed groove. A locking lever is pivotally connected outside the through hole. The locking lever includes a locking portion that is engagable in the recessed groove and a force-applying portion for pulling. The locking lever is pivotable between a locking position and an unlocking position. When the locking lever is pivoted to the locking position, the locking portion passes through the through hole and is engaged in the recessed groove to lock the adjusting cylinder so that adjusting cylinder cannot move axially along the threaded section. When the locking lever is pivoted to the unlocking position, the locking portion is disengaged from the recessed groove to unlock the adjusting cylinder.

### BRIEF DESCRIPTION OF THE DRAWINGS

FIG. 1 is a perspective view according to a first embodiment of the present invention;

FIG. 2 is a partial, radial, sectional view according to the first embodiment of the present invention;

FIG. 3 is a schematic view according to the first embodiment of the present invention, wherein the locking lever is at the locking position;

FIG. 4 is a schematic view according to the first embodiment of the present invention, wherein the locking lever is at the unlocking position;

FIG. 5 is a perspective view according to a second embodiment of the present invention;

FIG. 6 is a radial, sectional view according to the second embodiment of the present invention;

FIG. 7 is a perspective view according to a third embodiment of the present invention;

FIG. 8 is a partial, radial, sectional view according to the third embodiment of the present invention;

FIG. 9 is a radial, sectional view according to the third embodiment of the present invention; and

FIG. 10 is a perspective view according to a fourth embodiment of the present invention.

### DETAILED DESCRIPTION OF THE PREFERRED EMBODIMENTS

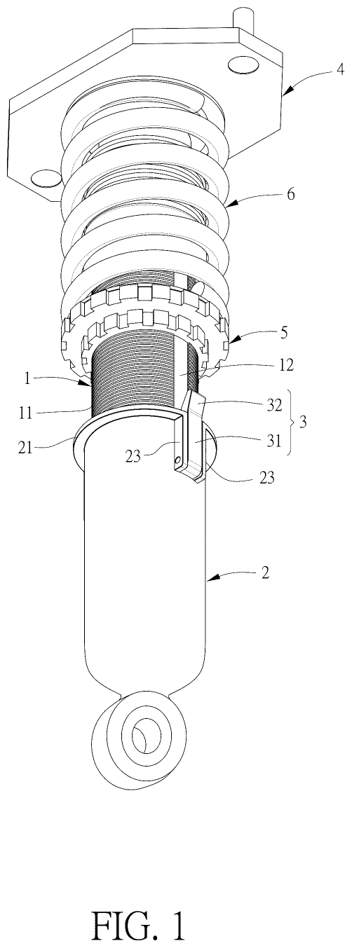

Referring to FIG. 1 through FIG. 5, a length-adjustable shock absorber according to a first embodiment of the present invention comprises a tubular body 1 and an adjusting cylinder 2.

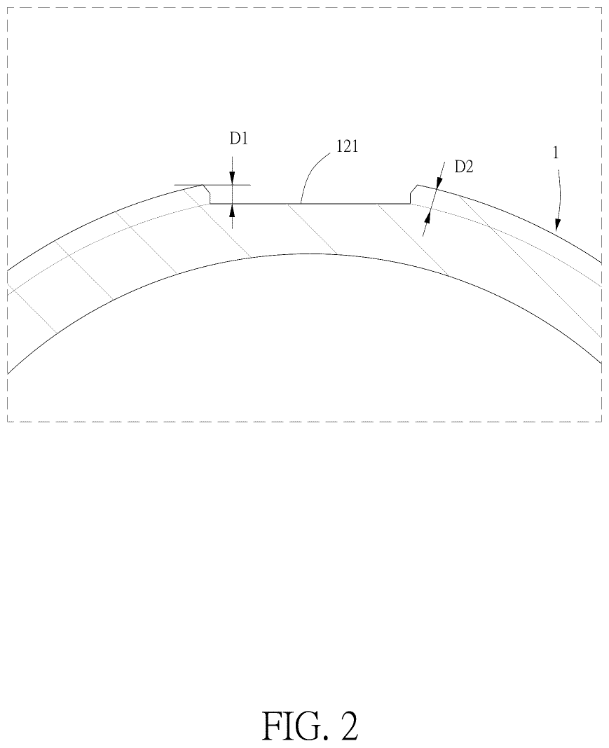

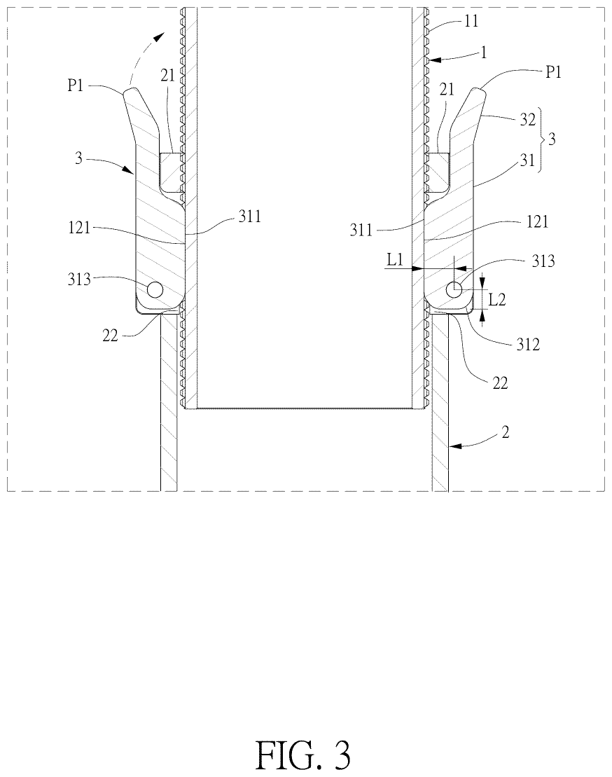

As shown in FIG. 1, one end of the tubular body 1 is formed with threads in an axial direction to form a threaded section 11. The threaded section 11 is interrupted in the axial direction by at least one recessed groove 12. As shown in FIG. 2, the recessed groove 12 has a flat bottom surface 121. The depth D1 of one side of the recessed groove 12, adjacent to the threaded section 11, is greater than or equal to the height D2 of the threads of the threaded section 11. The adjusting cylinder 2 is sleeved on the tubular body 1, and is threadedly connected to the tubular body 1 at a selective height. As shown in FIG. 1 and FIG. 3, one end face of the adjusting cylinder 2, facing the tubular body 1, extends outwardly to form a first annular projecting portion 21. The circumferential side of the adjusting cylinder 2 has at least one through hole 22 below the first annular projecting portion 21. The through hole 22 is rotated along with the adjusting cylinder 2 to face the recessed groove 12. In this embodiment, the threaded section 11 is interrupted in the axial direction by two recessed grooves 12 that are arranged symmetrically to form two discontinuous threaded areas. The depth D1 of one side of each recessed groove 12, adjacent to the threaded section 11, is equal to the height D2 of the threads of the threaded section 11. The circumferential side of the adjusting cylinder 2 has two symmetrical through holes 22. The through holes 22 are rotated along with the adjusting cylinder 2 to face the corresponding recessed grooves 12.

As shown in FIG. 1, two symmetrical extension portions 23 extending outwardly are disposed on two sides of the through hole 22. A locking lever 3 is pivoted between the two extension portions 23. The locking lever 3 is pivotable between a locking position P1 and an unlocking position P2. The locking lever 3 includes a locking portion 31 pivoted between the two extension portions 23 and a force-applying portion 32 extending from one end of the locking portion 31. Specifically, as shown in FIG. 3, when the force-applying portion 32 is pushed to pivot the locking portion 31 to the locking position P1, the locking portion 31 passes through the through hole 22 and is pressed against the recessed groove 12 to lock the adjusting cylinder 2, so that the adjusting cylinder 2 cannot rotate relative to the tubular body 1. At this time, one side of the locking portion 31, facing the through hole 22, is defined as a contact surface 311. The contact surface 311 is a flat surface that can fit with the flat bottom surface 121 of the recessed groove 12, thereby increasing the contact area between the locking portion 31 and the recessed groove 12 to ensure a stable locking position. In this embodiment, the locking lever 3 is pivoted in the axial direction toward one side of the tubular body 1 to the locking position P1. At this time, the force-applying portion 32 faces the first annular projecting portion 21. In order to ensure that the locking portion 31 is fully pressed in the recessed groove 12, the first annular projecting portion 21 has at least one first notch 211 for accommodating the force-applying portion 32. When the force-applying portion 32 is pulled to pivot the locking lever 31 to the unlocking position P2, the contact surface 311 of the locking lever 31 leaves the recessed groove 12, and another side of the locking lever 31, facing the through hole 22, is defined as a release surface 312. When the locking lever 31 is disengaged from the recessed groove 12, the adjusting cylinder 2 is unlocked. At this time, the adjusting cylinder 2 can rotate relative to the tubular body 1 to adjust the length.

Furthermore, as shown in FIG. 3, the locking portion 31 has a mounting hole 313 for pivoting. A first distance L1 is defined between the center of the mounting hole 313 and the contact surface 311. A second distance L2 is defined between the center of the mounting hole 313 and the release surface 312. The first distance L1 is greater than the second distance L2, thereby forming a pivot space for pivoting the locking lever 3 to complete the unlocking and locking actions.

Furthermore, as shown in FIG. 1, a mounting seat 4 is provided on one end of the tubular body 1, opposite to the adjusting cylinder 2, and is mounted to a car. A restricting ring 5 is threadedly connected between the mounting seat 4 and the adjusting cylinder 2. A spring 6 sleeved on the tubular body 1 is provided between the mounting seat 4 and the restricting ring 5. One end of the spring 6 is against the mounting seat 4, and the other end of the spring 6 is against the restricting ring 5, so that the spring 6 absorbs the vibration generated during the driving of the car to achieve a shock-absorbing effect.

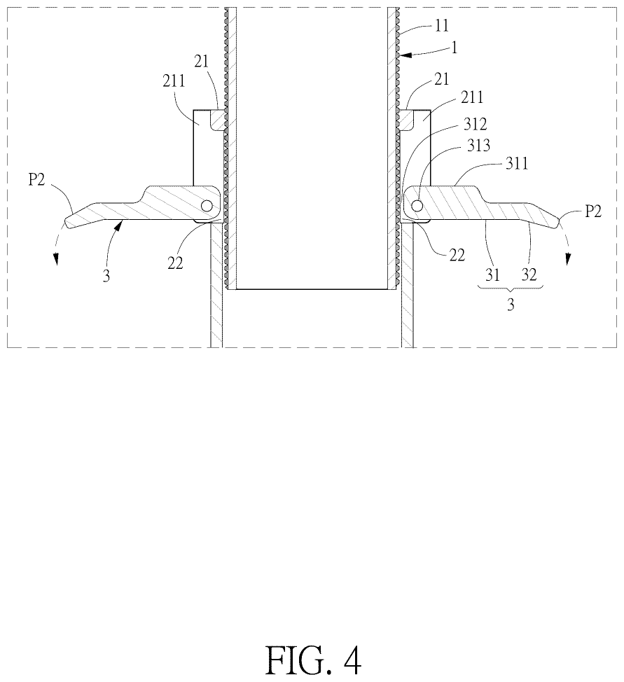

When the first embodiment of the present invention is actually used, as shown in FIG. 3, the adjusting cylinder 2 is rotated and screwed to the tubular body 1 at a selective height. After each through hole 22 is rotated to face the corresponding recessed groove 12, the force-applying portion 32 of the locking lever 3 is pulled to pivot the locking portion 31 toward one side of the tubular body 1 until the locking portion 31 passes through the through hole 22 and is engaged in the recessed groove 12. The contact surface 311 of the locking portion 31 is in contact with the flat bottom surface 121 of the recessed groove 12. At this time, the locking lever 3 is at the locking position P1 to lock the adjusting cylinder 2, so that the adjusting cylinder 2 cannot be rotated relative to the tubular body 1. When it is necessary to adjust the height of the adjusting cylinder 2 relative to the tubular body 1, as shown in FIG. 4, the force-applying portion 32 is pulled to pivot the locking portion 31 toward one side of the adjusting cylinder 2, the contact surface 311 of the locking portion 31 is disengaged from the recessed groove 12, the release surface 312 of the locking portion 31 faces the through hole 22, and the adjusting cylinder 2 is unlocked, so that the adjusting cylinder 2 can be rotated relative to the tubular body 1.

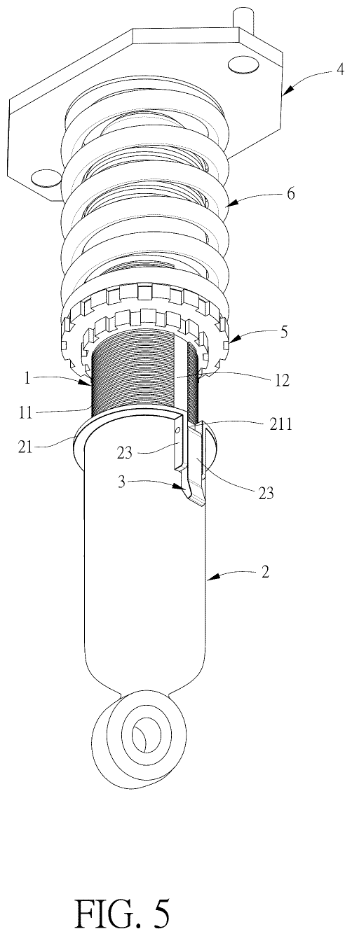

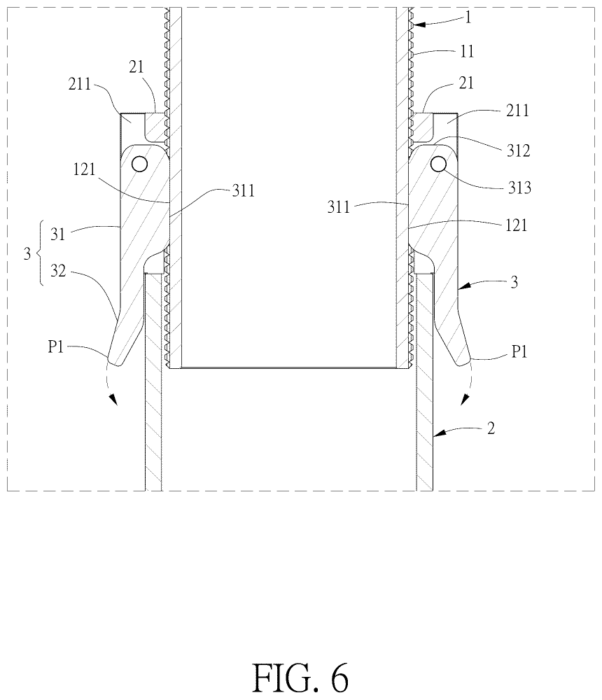

FIG. 5 and FIG. 6 show a second embodiment of the adjustable-length shock absorber provided by the present invention. The difference between the second embodiment and the above-mentioned first embodiment is that the locking lever 3 is pivoted axially toward one side opposite to the tubular body 1 to the locking position P1.

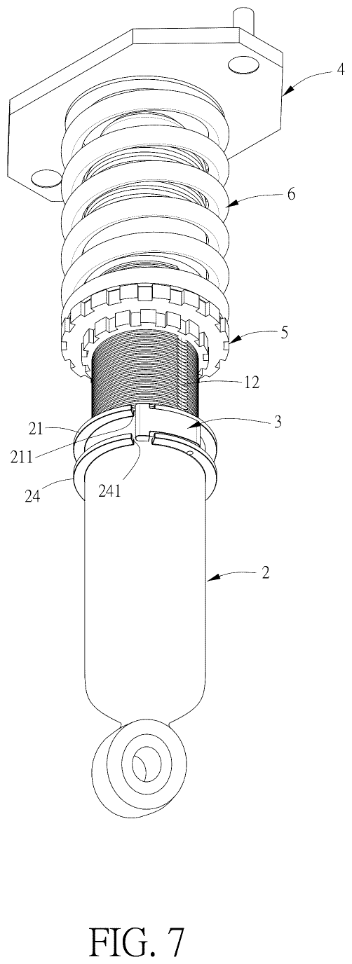

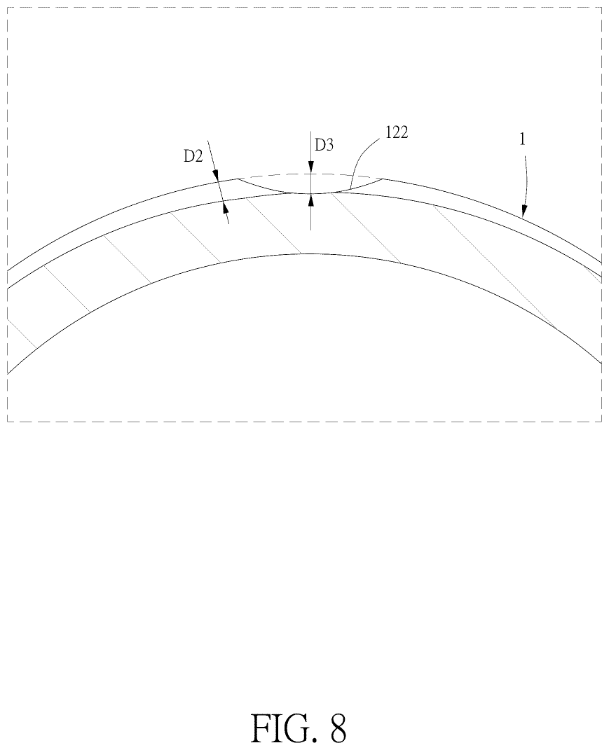

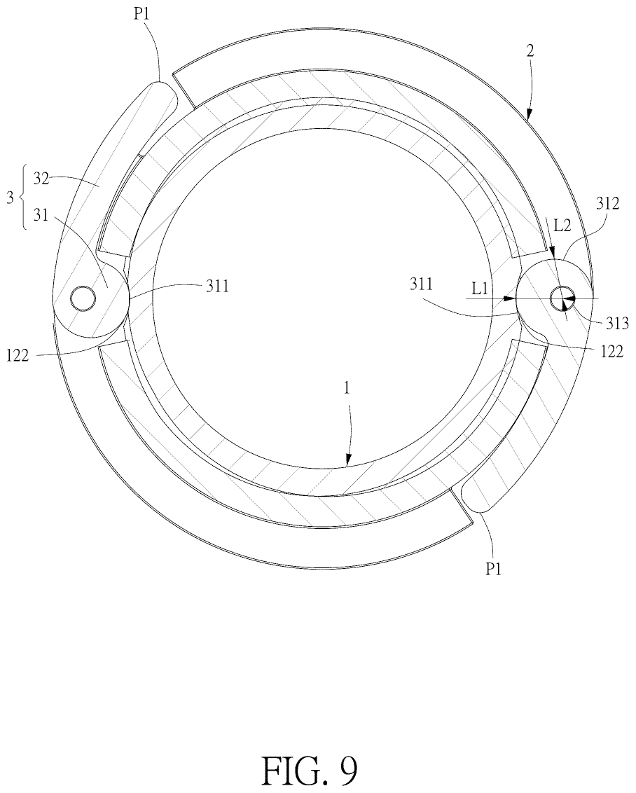

FIG. 7, FIG. 8 and FIG. 9 show a third embodiment of the adjustable-length shock absorber provided by the present invention. The third embodiment is substantially similar to the above-mentioned first embodiment with the exceptions described hereinafter. As shown in FIG. 8, the recessed groove 12 has a curved bottom surface 122, and the maximum depth D3 of the recessed groove 12 is equal to the height D2 of the threads of the threaded section 11. Referring to FIG. 7 and FIG. 9, one end face of the adjusting cylinder 2, facing the tubular body 1, extends outwardly to form a first annular projecting portion 21. A second annular projecting portion 24 is formed on the outer wall of the adjusting cylinder 2 under the first annular projecting portion 21. The through hole 22 is formed between the first annular projecting portion 21 and the second annular projecting portion 24. The locking lever 3 is pivoted between the first annular projecting portion 21 and the second annular projecting portion 24 through the locking portion 31, and is pivotable along the outer circumference of the adjusting cylinder 2. The locking lever 3 includes a T-shaped force-applying portion 32 and a locking portion 31 having a curved contact surface. The first annular projecting portion 21 and the second annular projecting portion 24 have a first notch 211 and a second notch 241 for accommodating the force-applying portion 32. As shown in FIG. 9, when the locking lever 3 is pivoted to the locking position P1, the contact surface 311 is in contact with the curved bottom surface 122 of the recessed groove 12, and the force-applying portion 32 is accommodated in the first notch 211 and the second notch 241.

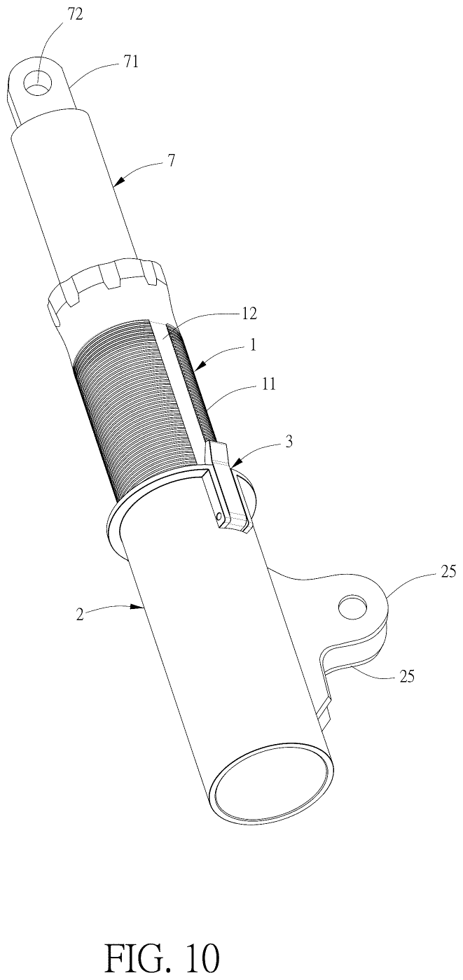

FIG. 10 shows a fourth embodiment of the adjustable-length shock absorber provided by the present invention. A shock-absorbing rod 7 is mounted on one end of the tubular body 1, opposite to the adjusting cylinder 2. The tubular body communicates with the shock-absorbing rod to form an inner tubular cavity (not shown in the figures). A hydraulic shock-absorbing mechanism (not shown in the figures) is provided in the inner tubular cavity. The end of the shock-absorbing rod 7 has a pivot portion 71. The pivot portion 71 has a pivot hole 72 for the pivot portion 71 to be pivotally mounted to a motorcycle body. The adjusting cylinder 2 has two symmetrical mounting portions 25 extending outwardly on the circumferential side of one end of the adjusting cylinder 2 far away from the tubular body 1. The two mounting portions 25 are spaced apart from each other for mounting a motorcycle wheel.

As disclosed in the adjustable-length shock absorber provided by the present invention, when the locking portion 31 of the locking lever 3 is pivoted to pass through the through hole 22 and is pressed against the recessed groove 12, the locking lever 3 is at the locking position P1 and the adjusting cylinder 2 is a locking state. This solves the problem of mud/sand sediment between the threads, which makes it difficult to rotate the retaining ring for adjusting the length. The present invention achieves the effect of easy installation and adjustment. Besides, when the locking lever 3 is engaged in the recessed groove 12, the adjusting cylinder 2 cannot be rotated relative to the tubular body 1, which solves the problem that the long-term driving vibration causes a gap formed between the adjusting cylinder 2 and the tubular body 1 to affect the effect of shock absorption. The present invention achieves the effect that the adjusting cylinder is not easy to come loose and does not produce a noise.

What is claimed is:

1. A length-adjustable shock absorber, comprising:
a tubular body, having one end formed with threads in an axial direction to form a threaded section, the threaded section being interrupted in the axial direction by at least one recessed groove;
an adjusting cylinder, sleeved on the tubular body, the adjusting cylinder being threadedly connected to the tubular body at a selective height for adjusting a length that the tubular body extends out of the adjusting cylinder;
wherein a circumferential side of the adjusting cylinder has at least one through hole, the through hole is rotated along with the adjusting cylinder to face the recessed groove, a locking lever is pivotally connected outside the through hole, the locking lever includes a locking portion that is engagable in the recessed groove and a force-applying portion for pulling, and the locking lever is pivotable between a locking position and an unlocking position; when the locking lever is pivoted to the locking position, the locking portion passes through the through hole and is engaged in the recessed groove to lock the adjusting cylinder so that adjusting cylinder cannot move axially along the threaded section; when the locking lever is pivoted to the unlocking position, the locking portion is disengaged from the recessed groove to unlock the adjusting cylinder.

2. The length-adjustable shock absorber as claimed in claim 1, wherein the at least one recessed groove includes two recessed grooves that are arranged symmetrically, the threaded section of the tubular body is interrupted in the axial direction by the two recessed grooves, the at least one through hole includes two through holes that are arranged symmetrically, and the through holes are rotated along with the adjusting cylinder to face the corresponding recessed grooves.

3. The length-adjustable shock absorber as claimed in claim 1, wherein the locking portion has a mounting hole for pivoting; when the locking portion is pivoted to the locking position, one side of the locking portion, facing the through hole, is defined as a contact surface, and a first distance is defined between a center of the mounting hole and the contact surface; when the locking portion is pivoted to the unlocking position, another side of the locking portion, facing the through hole, is defined as a release surface, a second distance is defined between the center of the mounting hole and the release surface, and the first distance is greater than the second distance.

4. The length-adjustable shock absorber as claimed in claim 3, wherein the recessed groove has a flat bottom surface, the recessed groove has a depth greater than or equal to a height of the threads of the threaded section, the contact surface of the locking portion is a flat surface, when the locking portion is pivoted to the locking position, the contact surface is pressed against the flat bottom surface of the recessed groove.

5. The length-adjustable shock absorber as claimed in claim 3, wherein the recessed groove has a curved bottom surface, the recessed groove has a maximum depth greater than or equal to a height of the threads of the threaded section, the contact surface of the locking portion is a curved surface, when the locking portion is pivoted to the locking position, the contact surface is pressed against the curved bottom surface of the recessed groove.

6. The length-adjustable shock absorber as claimed in claim 1, wherein one end face of the adjusting cylinder, facing the tubular body, extends outwardly to form a first annular projecting portion, the through hole is located below the first annular projecting portion, two symmetrical extension portions extending outwardly are disposed on two sides of the through hole, the locking lever is pivotally connected between the two extension portions, the locking lever is pivoted in the axial direction toward one side of the tubular body to the locking position, and the first annular projecting portion has at least one first notch for accommodating the force-applying portion.

7. The length-adjustable shock absorber as claimed in claim 1, wherein the locking lever is pivoted in the axial direction toward one side opposite to the tubular body to the locking position.

8. The length-adjustable shock absorber as claimed in claim 1, wherein one end face of the adjusting cylinder, facing the tubular body, extends outwardly to form a first annular projecting portion, a second annular projecting portion is formed on an outer wall of the adjusting cylinder under the first annular projecting portion, the through hole is formed between the first annular projecting portion and the second annular projecting portion, the locking lever is pivotally connected between the first annular projecting portion and the second annular projecting portion and is pivotable in a radial direction of the adjusting cylinder, and the first annular projecting portion and the second annular projecting portion have a first notch and a second notch for accommodating the force-applying portion.

9. The length-adjustable shock absorber as claimed in claim 1, wherein a mounting seat is provided on one end of the tubular body, opposite to the adjusting cylinder, a restricting ring is threadedly connected between the mounting seat and the adjusting cylinder, a spring sleeved on the tubular body is provided between the mounting seat and the restricting ring, one end of the spring is against the mounting seat, and another end of the spring is against the restricting ring.

10. The length-adjustable shock absorber as claimed in claim 1, wherein a shock-absorbing rod is mounted on one end of the tubular body, opposite to the adjusting cylinder, one end of the shock-absorbing rod has a pivot portion, the pivot portion has a pivot hole for pivot mounting, the adjusting cylinder has two symmetrical mounting portions extending outwardly on the circumferential side of one end of the adjusting cylinder far away from the tubular body, and the two mounting portions are spaced apart from each other.
